(19) United States
(12) Patent Application Publication
(10) Pub. No.: US 2004/0224261 A1
(43) Pub. Date: Nov. 11, 2004

(54) Unitary dual damascene process using imprint lithography

(76) Inventors: Douglas J. Resnick, Gilbert, AZ (US); Scott D. Hector, Austin, TX (US); Richard D. Peters, Austin, TX (US)

Correspondence Address: FREESCALE SEMICONDUCTOR, INC., LAW DEPARTMENT, 7700 WEST PARMER LANE MD:TX32/PL02, AUSTIN, TX, 78729, US

(21) Appl. No.: 10/434,614

(22) Filed: May 8, 2003

(51) Int. Cl. B05D 3/00

(52) U.S. Cl. 430/311; 427/271

(57) ABSTRACT

An exemplary method for using multi-tiered templates with imprint lithography for producing dual damascene features is disclosed as comprising the steps of inter alia: positioning (step 150) a multi-tiered lithographic template (130) in contact with a resist layer (120); applying pressure to the template (130) so that the resist material (120) flows into the relief pattern of the template (130) thereby forming a patterned resist layer (125); optionally curing the patterned resist layer (125); removing (step 160) the template (130) from the patterned resist layer (125); and etching (steps 170, 180) the patterned resist layer (125) to develop a via-and-trench pattern in the patterning layer (117). Disclosed features and specifications may be variously controlled, configured, adapted or otherwise optionally modified to further improve or otherwise optimize the fabrication of dual damascene or other multi-tiered structures.

### FIELD OF INVENTION

The present invention relates to semiconductor devices, microelectronic devices, microelectromechanical devices, microfluidic devices, photonic devices, and semiconductor processing techniques; and more particularly, in various representative and exemplary embodiments, to lithographic templates, methods of forming lithographic templates, and methods for fabricating multi-tiered structures with lithographic templates.

### BACKGROUND

The fabrication of integrated circuits involves the creation of several layers of materials that interact in some fashion. One or more of these layers may be patterned so various regions of the layer have different electrical characteristics, which may be interconnected within the layer or to other layers to create electrical components and circuits. These regions may be created by selectively introducing or removing various materials. The patterns that define such regions are often created by lithographic processes. For example, a layer of photoresist material may be applied onto a layer overlying a wafer substrate. A photomask (containing clear and opaque areas) may then be used to selectively expose the photoresist material by a form of radiation, such as ultraviolet light, electrons, or x-rays. Either the photoresist material exposed to the radiation, or that not exposed to the radiation, is thereafter removed by the application of a developer. An etch may then be applied to the layer not protected by the remaining resist, whereupon removal of the remaining resist exposes a patterned layer overlying the substrate.

Lithographic processes such as those described vide supra are typically used to transfer patterns from a photomask to a device. As feature sizes on semiconductor devices decrease into the sub-micron range, there is a need for new lithographic processes, or techniques, to pattern high-density semiconductor devices. Several new lithographic techniques which accomplish this having a basis in printing and stamping have been proposed. One in particular, Step and Flash Imprint Lithography (SFIL) has been shown to be capable of patterning lines as small as 20 nm, resulting in the ability to realize a wide variety of feature sizes on a single wafer. Moreover, SFIL techniques generally benefit from the use of photochemistry, ambient temperatures, and the low pressure typically employed to carry out the SFIL process.

Conventional methods for fabricating damascene or tiered structures typically involve substantial complexities with respect to inter alia lithographically defining multiple metal layers using numerous processing steps. These complexities tend to dramatically increase manufacturing costs. Consequently, elimination of processing steps would be expected to significantly reduce cost of ownership as well as costs of production.

### SUMMARY OF THE INVENTION

In various representative aspects, the present invention provides a system and method for using multi-tiered templates with imprint lithography for the patterning of trenches and vias in dual damascene processes. An exemplary method is disclosed as comprising the steps of inter alia: positioning a multi-tiered lithographic template in contact with, for example, a resist layer; applying pressure to the template or positioning the template in close proximity to the substrate and relying on capillary action so that the contacted material flows into the relief pattern of the template thereby forming a patterned resist layer; optionally curing the patterned resist layer; removing the template from the patterned resist layer; and (in the exemplary case of resist processing) etching the patterned resist layer to develop a via-and-trench pattern in the patterning layer. Alternatively, the template may be used to directly pattern an electrically insulating photo-curable material that has a low dielectric constant. This patterned material may be inlaid with metal to form vias and metal interconnections with the patterned material serving inter alia to electrically isolate the interconnects and vias while also minimizing the capacitive coupling between them. Fabrication is relatively simple and straightforward. Additional advantages of the present invention will be set forth in the Detailed Description which follows and may be obvious from the Detailed Description or may be learned by practice of exemplary embodiments of the invention. Still other advantages of the invention may be realized by means of any of the instrumentalities, methods or combinations particularly pointed out in the claims.

### BRIEF DESCRIPTION OF THE DRAWING

Representative elements, operational features, applications and/or advantages of the present invention reside inter alia in the details of construction and operation as more fully hereafter depicted, described and claimed—reference being made to the accompanying drawings forming a part hereof, wherein like numerals refer to like parts throughout. Other elements, operational features, applications and/or advantages will become apparent to skilled artisans in light of certain exemplary embodiments recited in the Detailed Description, wherein:

FIG. 1 representatively illustrates a cross-sectional view of an imprint lithography process in accordance with one exemplary aspect of the present invention; and

FIG. 2 representatively illustrates a cross-sectional view of another imprint lithography process in accordance with another exemplary aspect of the present invention.

Those skilled in the art will appreciate that elements in the Figures are illustrated for simplicity and clarity and have not necessarily been drawn to scale. For example, the dimensions of some of the elements in the Figures may be exaggerated relative to other elements to help improve understanding of various embodiments of the present invention. Furthermore, the terms ‘first’, ‘second’, and the like herein, if any, are used inter alia for distinguishing between similar elements and not necessarily for describing a sequential or chronological order. Moreover, the terms front, back, top, bottom, over, under, and the like in the Description and/or in the claims, if any, are generally employed for descriptive purposes and not necessarily for comprehensively describing exclusive relative position. Skilled artisans will therefore understand that any of the preceding terms so used may be interchanged under appropriate circumstances such that various embodiments of the invention described herein, for example, are capable of operation in other orientations than those explicitly illustrated or otherwise described.

### DETAILED DESCRIPTION OF EXEMPLARY EMBODIMENTS

The following descriptions are of exemplary embodiments of the invention and the inventors' conceptions of the best mode and are not intended to limit the scope, applicability or configuration of the invention in any way. Rather, the following Description is intended to provide convenient illustrations for implementing various embodiments of the invention. As will become apparent, changes may be made in the function and/or arrangement of any of the elements described in the disclosed exemplary embodiments without departing from the spirit and scope of the invention.

A detailed description of an exemplary application, namely a system and method for using multi-tiered templates with imprint lithography for the patterning of trenches and vias in dual damascene processes is presented as a specific enabling disclosure that may be readily generalized by skilled artisans to any application of the disclosed system and method in accordance with various embodiments of the present invention.

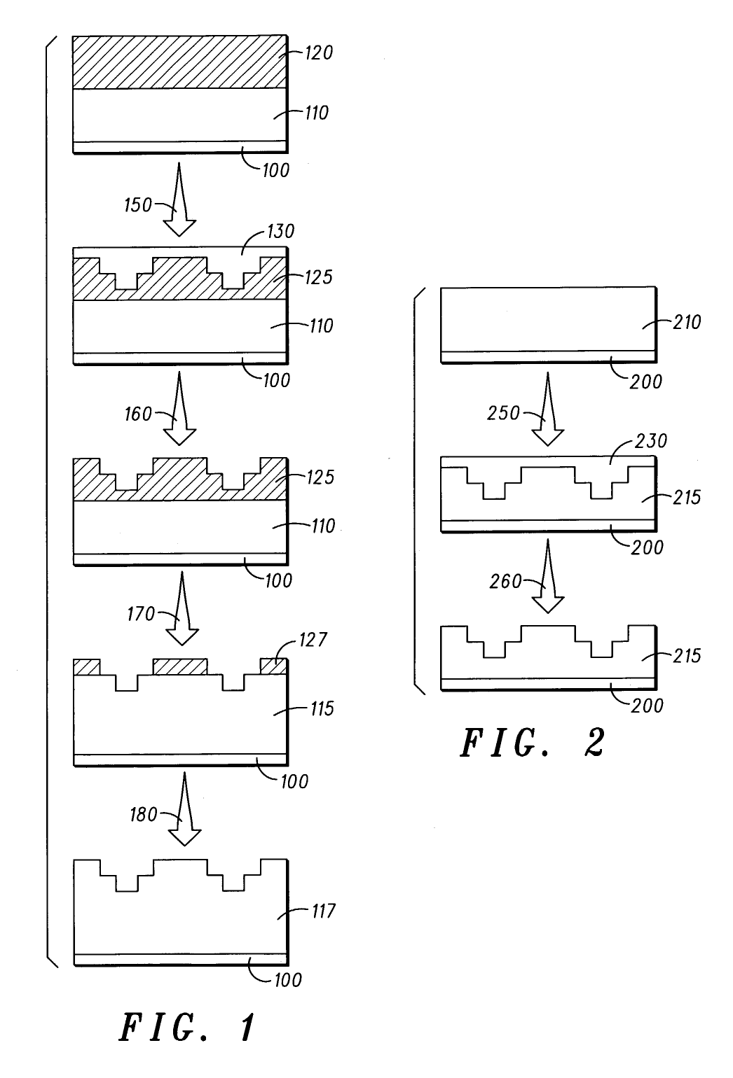

As representatively illustrated in FIG. 1, a substrate 100 is configured with a patterning layer 110 disposed over a first surface of substrate 100. A photoresist layer 120 may then be deposited over patterning layer 110 using any method or resist deposition technique whether now known or hereafter described in the art. In certain exemplary embodiments, photoresist layer 120 may comprise any radiation sensitive material, such as, for example: organic compounds; photosensitive; or photoimageable compounds. Patterning layer 110, may comprise, for example, any dielectric material. Resist layer 120 may be disposed on patterning layer 110 using inter alia standard spin-coating techniques, thereby providing resisting layer 120 with a relatively planar exposed surface.

In certain exemplary embodiments, in accordance with various representative aspects of the present invention, substrate 100 may comprise, for example: a semiconductor material; a III-V compound semiconductor; a glass; a metal; a metal alloy; Si; quartz; a polymer; a crystalline material and/or an amorphous material. Additionally, substrate 100 may further comprise overlying devices and/or device layers which themselves may comprise, for example, polysilicon, oxide, metal, etc., as well as trench and diffusion regions or features and/or the like.

A multi-tiered lithographic template 130 may then be brought within proximity to the exposed surface of resist layer 120. Thereafter, template 130 may be placed adjacent resist layer 120 with pressure and optionally heat applied (see step 150) to template 130 so that the radiation sensitive material layer 125 flows into the relief features of template 130 due to the pressure or by capillary action. In one exemplary embodiment, in accordance with the present invention, radiation may then transmitted through the lithographic template 130 and imaged onto the radiation sensitive material layer 125 overlying the substrate 100.

Template 130 may ideally be formed as a multi-tiered structure having a transparent conductive layer present therein. Further information on the fabrication of such multi-tiered lithographic templates may be found, for example, in pending U.S. Patent application, bearing Ser. No. 10/081,199, and attorney docket number CR 01-031, filed Feb. 22, 2002, entitled “METHOD OF FABRICATING A TIERED STRUCTURE USING A MULTI-LAYERED RESIST STACK AND USE”, assigned to the same assignee and incorporated herein by reference.

Template 130 may thereafter be removed (see step 160) from the device, thereby leaving a patterned resist layer 125 which may then used as an image layer for subsequent processing of patterning layer 110. In certain exemplary and representative embodiments of the present invention, photoresist layer 125 may serve as a mask, for example in conjunction with ion implantation to form implanted regions in the semiconductor substrate, or may be used in conjunction with conventional wet or dry etches (see steps 170, 180) to transfer the pattern into patterned layer 117, or into other device layers overlying the semiconductor substrate 100. Representatively depicted, for example, a first partial etch (step 170) may be performed to produce an at least partially patterned layer 115. Thereafter, further etching (step 180) may be performed to realize a substantially complete via-and-trench patterned layer 117.

It should be understood that although the template fabricated in accordance with the illustrated embodiment is described as being used to fabricate a semiconductor device, anticipated also is the use of a template, generally similar to template 130 to form inter alia microelectronic devices, microelectromechanical devices, photonic devices, microfluidic devices and/or the like. It will also be appreciated by skilled artisans, that the disclosed method comprises a single photo-step thereby defining a substantially unitary dual damascene process using imprint lithographic techniques.

In an alternative exemplary embodiment, as generally depicted for example in FIG. 2, a patterning layer 210 disposed over a substrate 200 may be provided for substantially direct imprinting (see step 250) with multi-tiered template 230 without the use of, for example, photoresist materials. In such representative embodiments, the temperature of patterning material 210 and/or the pressure used to apply template 230, so as to transfer patterning to patterned layer 215 prior to template 230 removal (see step 260), may be modified to produce a substantially similar result without the need for photo imaging.

In the foregoing specification, the invention has been described with reference to specific exemplary embodiments; however, it will be appreciated that various modifications and changes may be made without departing from the scope of the present invention as set forth in the claims below. The specification and figures are to be regarded in an illustrative manner, rather than a restrictive one and all such modifications are intended to be included within the scope of the present invention. Accordingly, the scope of the invention should be determined by the claims appended hereto and their legal equivalents rather than by merely the examples described above. For example, the steps recited in any method or process claims may be executed in any order and are not limited to the specific order presented in the claims. Additionally, the components and/or elements recited in any apparatus claims may be assembled or otherwise operationally configured in a variety of permutations to produce substantially the same result as the present invention and are accordingly not limited to the specific configuration recited in the claims.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components of any or all the claims.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted by those skilled in the art to specific environments, manufacturing specifications, design parameters or other operating requirements without departing from the general principles of the same.

We claim:

1. A method for producing a device having a via-and-trench pattern defined by imprint lithography, said method comprising the steps of:
providing a multi-tiered lithographic template;
providing a substrate having a surface;
providing a patterning layer disposed on the surface of said substrate;
providing a resist layer disposed on said patterning layer;
positioning said lithographic template in contact with said resist layer, said resist layer being disposed substantially between the template and the substrate;
applying pressure to the template, the resist material thereby flowing into the relief pattern of the template to form a patterned resist layer;
optionally curing said patterned resist layer;
removing said template from said patterned resist layer; and
etching said patterned resist layer to at least partially remove said resist layer to at least partially develop a via-and-trench pattern in said patterning layer.

2. The method of claim 1, wherein said substrate comprises at least one of:
a III-V compound semiconductor; glass; a metal; a metal alloy; Si;
quartz; a polymer; a crystalline material; and an amorphous material.

3. The method of claim 1, wherein said patterning layer comprises a dielectric.

4. The method of claim 1, wherein said resist layer comprises a low to medium molecular weight, soluble, organic imageable material.

5. The method of claim 1, wherein the step of curing said patterned resist layer includes the step of exposing the resist layer to at least one of a heat source, a light source, and an electron beam source.

6. The method of claim 5, wherein the step of curing said patterned resist layer comprises transmitting radiation through the lithographic template.

7. The method of either of claims 5 or 6, wherein said radiation comprises ultraviolet light.

8. The method of claim 1, wherein said device comprises at least one of: a semiconductor device; a microelectronic device; a microelectromechanical device; a photonic device; and a microfluidic device.

9. A device having a via-and-trench feature fabricated in accordance with the method of claim 1.

10. The device of claim 9, wherein said via-and-trench feature comprises a dual damascene structure.

11. The device of claim 9, wherein said substrate comprises at least one of:
a III-V compound semiconductor; glass; a metal; a metal alloy; Si;
quartz; a polymer; a crystalline material; and an amorphous material.

12. The device of claim 9, wherein said patterning layer comprises a dielectric.

13. The device of claim 9, wherein said resist layer comprises a low to medium molecular weight, soluble, organic imageable material.

14. The device of claim 9, wherein said device comprises at least one of: a semiconductor device; a microelectronic device; a
microelectromechanical device; a photonic device; and a microfluidic device.

15. A method for producing a device having dual damascene features defined by imprint lithography, said method comprising the steps of:
providing a multi-tiered lithographic template;
providing a substrate having a surface;
providing a patterning layer disposed on the surface of said substrate;
positioning said lithographic template in contact with said patterning layer, said patterning layer being disposed substantially between the template and the substrate;
applying pressure to the template, the patterning layer material thereby flowing into the relief pattern of the template to form a patterned patterning layer;
optionally curing said patterned patterning layer; and
removing said template from said patterning layer to expose a via-and-trench pattern in said patterning layer.

16. The method of claim 15, wherein said substrate comprises at least one of: a III-V compound semiconductor; glass; a metal; a metal alloy; Si; quartz; a polymer; a crystalline material; and an amorphous material.

17. The method of claim 15, wherein said patterning layer comprises a dielectric, heat-curable or photo-curable dielectric material.

18. The method of claim 15, wherein said patterning layer comprises a low to medium molecular weight, soluble, organic imageable material.

19. The method of claim 15, wherein the step of curing said patterned patterning layer includes the step of exposing the patterned patterning layer to at least one of a heat source, a light source, and an electron beam source.

20. The method of claim 19, wherein the step of curing said patterned patterning layer comprises transmitting radiation through the lithographic template.

21. The method of either of claims 19 or 20, wherein the radiation comprises ultraviolet light.

22. The method of claim 15, wherein said device comprises at least one of:
a semiconductor device; a microelectronic device; a microelectromechanical device; a photonic device; and a microfluidic device.
